(19) United States
(12) Patent Application Publication
(10) Pub. No.: US 2007/0204719 A1
(43) Pub. Date: Sep. 6, 2007

(54) Highway safety scoop

(76) Inventors: Timothy P. Tamplin, Ronkonkoma, NY (US); Steven Racioppi, Islip, NY (US)

Correspondence Address: Timothy P Tamplin, 129 Springdale Dr., Ronkonkoma, NY, 11779, US

(21) Appl. No.: 11/366,973

(22) Filed: Mar. 3, 2006

(51) Int. Cl. G05G 5/06

(52) U.S. Cl. 74/532

(57) ABSTRACT

The Highway Safety Scoop is made of thin steel or aluminum, it has a flat bottom, two sides, a back and a grapple holding setup. With its deep, thin, flat bottom this scoop is designed for one thing, to scrape up debris on the road. At first glance this scoop looks very familiar. Under closer observation you can see this scoop is not heavy enough or designed in any way to act as a loader or for digging of any kind, not dirt, rock or any materials to be picked up in one Location and dumped in another. It will have little vertical movement and cant dump as loader does, and no Side to side movement as a snow plow does to deflect snow. When deployed by the highway departments, Fitting the trucks with this scoop to remove debris such as dead animals and tires from our highways safely and fast will cut down on related accidents and injury to maintenance personnel.

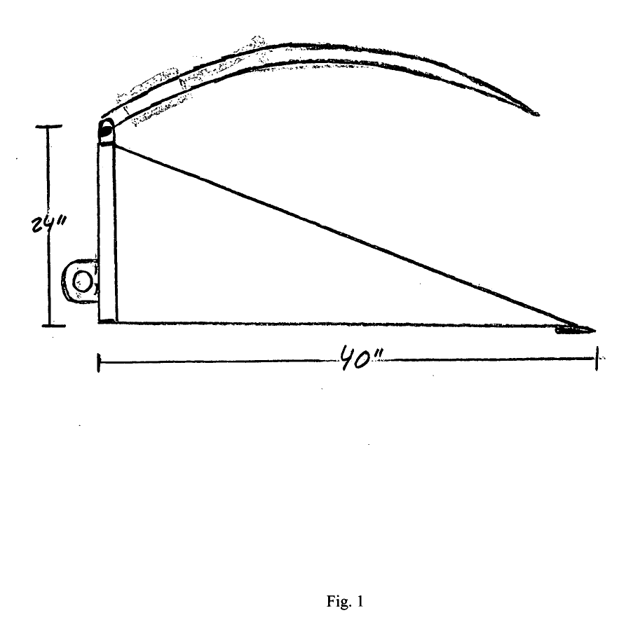

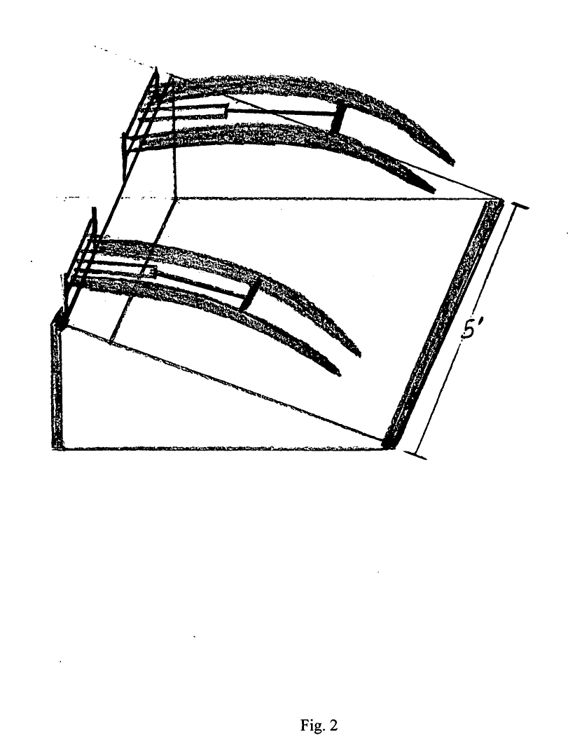

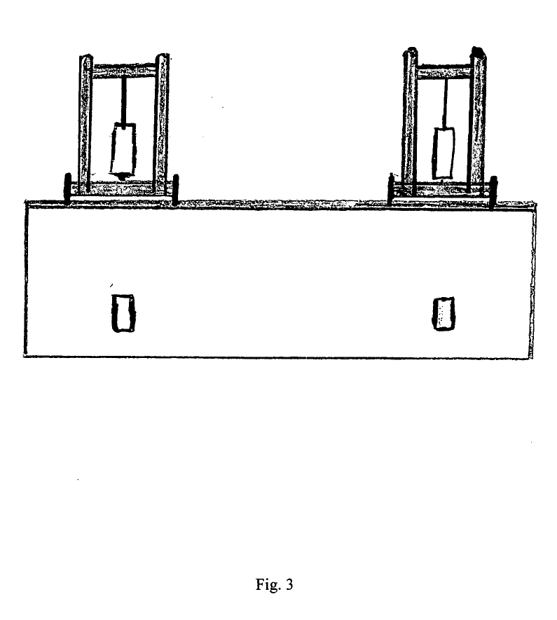

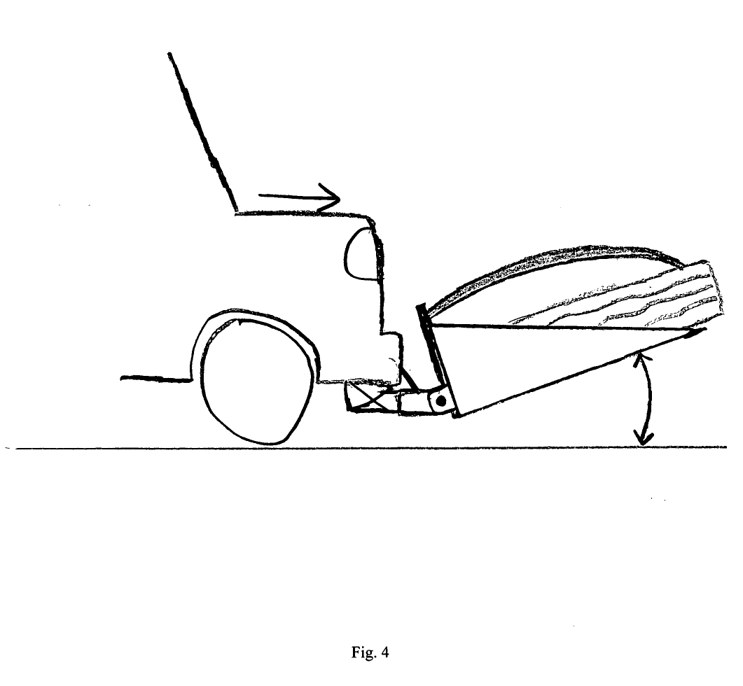

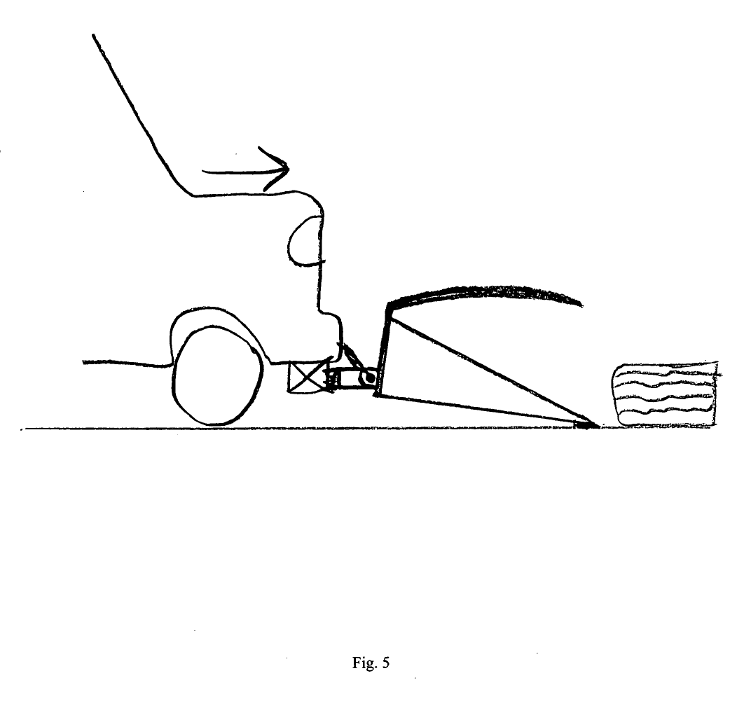

### BACKGROUND of the INVENTION

While driving across country I, Timothy Tamplin, encountered numerous road debris varying in size and shape, including tires, road kill, buckets, wood, etc. One day while driving in Texas I struck a truck tire retread that tore a huge chunk out of my car sending me swerving before I regained control. I first thought of this invention shortly after that. I Then Took my ideas to Steve Racioppi and together we came up with the final product.

The Highway Safety Scoop would fall under road construction or maintaining Category. It would most likely be used by highway departments. At a glance the scoop Looks like one used by a loader at a construction site, but ours has a flat bottom area And is much lighter for use on a truck. Its movement will be similar to a snow plow, raising and lowering the specially designed scoop up and down to retrieve debris. Grapples like ours are used on construction vehicles now. Our scoop is specially designed to have the right weight and strength requirements, the ability to raise and lower to do the job of debris removing, all while mounted on the front of a truck. This scoop is not intended to turn a truck into payloader or bobcat type vehicle, it isn't designed for that job at all.

### BRIEF SUMMARY OF THE INVENTION

Road Debris of any kind poses a hazard to all drivers and workers trying to remove it! Removing the debris as fast as possible can mean life or death for someone down the road. On today's overcrowded fast moving highways and Interstates stopping or slowing down traffic requires the use of many trucks and a person or persons to physically pick up and remove the debris. A truck equipped with The Highway Safety Scoop could remove debris big or small without putting anyone in danger. The Highway Safety Scoop is a truck mounted system that can be lowered in front of debris scoop it up and hold it in place until off the highway.

### DETAILED DESCRIPTION OF THE INVENTION

The Highway Safety Scoop is a truck mounted scoop (also called a bucket) System. Many off road construction vehicles have a scoop. Example: Backhoe or Pay loader. The Highway Safety Scoop is constructed from lightweight aluminum or thin steel to reduce weight for mounting on trucks. The scoops primary objective is also different. Its purpose is not to dig, but skim the road to remove Large or small debris safe and easy. Our scoop is flat on the bottom and the depth of our scoop from front to rear is deeper then traditional pay loader scoops of similar size. This is to provide more room for large debris. It is designed to use the forward momentum of the truck, the angle and thin blade to remove Road kill as big as a full size male deer, or as small as a baseball size rock in the road. The faster objects are removed from our fastmoving Highways, the safer it is for everyone. Also not putting someone in harm way trying to remove the debris from the road will benefit the highway workers.

The Highway Safety Scoops movement will be similar to that of a snow plow with hydraulic pistons on the scoop controlled from inside the truck moving the scoop up and down and also applying the grapple's to be lowered to hold the object safely in place while leaving the highway.

Unlike a snow plow the Highway Safety Scoop does not swing left and right for snow deflection purposes. Also the scoop is different from construction vehicles for it is not designed to dig or dump earth or rock. The thin steel could never take those demands. This scoop is designed for the job of removing road debris and mounting to existing state or county trucks in service right now. When not in use the scoop will be in stow position perpendicular to the front of the vehicle to give the best vision for the driver

Here I will explain how the Highway safety Scoop will be used by highway departments of the future. A highway worker driving a truck with the Highway safety Scoop mounted, may see or get a call about a tire and rim sitting in a lane of a major Interstate. Its only a matter of time before someone hits it and it starts doing damage to other vehicles. After locating the tire and rim the driver next gets himself in the lane on course with the debris but still a half mile out. He will than put his hazards on and begin to slow down gradually. The scoop will be lowered but still off the ground until he closes in. The driver at 10-15 mph will skim the pavement scoop up the tire and rim then lower the grapple arm to secure the load and proceed with caution to leave the highway.

As for the process of making the highway scoop, it will probably change when it Goes to production but ours will be welded plates of ⅛ inch steel with reinforcements for Strength. ⅛ inch is thin compared to a digging and dumping scoop on a payloader which may be ¾ to 2 inches thick and very heavy. This welded scoop will be fitted with grapple assemblies to hold the load in place. Now this whole scoop assembly (the scoop and Grapples) is welded to a modified truck with a similar setup a plow to move the scoop up and down and also activate the grapples. The dimensions of the scoop will vary depending on the size of the truck. The large state or town trucks may use a bigger scoop than the smaller one's. The scoop does not exceed the width of the truck.

I believe others have invented a scoop setup to try and turn a truck into some kind of a loader that can scoop up rock or dirt and dump it somewhere else. Our scoop is strictly built for one job, with its flat bottom, the scoop will pick up road debris, tilt back and also grab down with the grapples.

The Highway Safety Scoop would be a great addition to the highway departments Across the country. If trucks are equipped and ready for use, this product will prove itself By preventing accidents and saving lives.

1. We claim this invention is a front mounted truck scoop with the intent of removing road debris, consisting of a flat bottomed scoop made from steel or aluminum, two piston Actuated grapples attached to the scoop to hold debris, with the ability for up and down movement of the Scoop and the grapples which will be controlled inside the cab of the truck with a joystick.

2. As claimed in claim one this invention is a front mounted truck scoop with the intent of removing road debris.

3. As claimed in claim one this invention is a truck mounted steel or aluminum scoop with up and down movement to scoop road debris and hold with grapples.

4. As claimed in claim one this invention is a truck mounted truck scoop with up and down movement with intent of removing road debris and controlled from inside the cab of the truck.

5. We claim this invention is a Steel or aluminum front mounted vehicle scoop with a flat bottom, two sides, and a back, designed to raise and lower to scoop up road debris, then has the ability to secure the load with the use of a grapple system.

6. As claimed in claim five this invention is a steel or aluminum front mounted vehicle scoop with a flat bottom, two sides, and a back.

7. As claimed in claim five this invention is a front mounted vehicle scoop that raises and lowers to scoop debris, then has the ability to secure the load with the use of a grapple system.

8. We claim this invention is a truck mounted road debris removal system consisting of a flat bottomed scoop with grapples which can be raised and lowered with controls inside the cab to scrape debris off the road and hold it until a safe distance from Highway.

9. As claimed in claim eight this invention is a truck mounted road debris removal system consisting of a flat bottomed scoop with grapples.

10. As claimed in claim eight this invention is a truck mounted scoop which can be raised and lowered to scrape debris off the road.

11. As claimed in claim eight this invention is truck mounted scoop that can be raised and lowered with controls from inside the cab.

12. As claimed in claim eight this invention is a road debris removal system designed to scrape debris off the road.
